(19) United States
(12) Patent Application Publication
(10) Pub. No.: US 2026/0107362 A1
(43) Pub. Date: Apr. 16, 2026

(54) LIGHTING FIXTURE WITH SUPERIMPOSED, INDIVIDUALLY CONTROLLABLE GROUPS OF LEDS CREATING A LIGHTING EFFECT

(71) Applicant: CHAUVET & SONS,LLC, Davie, FL (US)

(72) Inventors: Chen Xiaowen, Zhongshan City (CN); Hu Zezhou, Zhongshan City (CN); Cao Dianwei, Zhongshan City (CN); Wen Qilong, Zhongshan City (CN)

(21) Appl. No.: 19/357,656

(22) Filed: Oct. 14, 2025

Related U.S. Application Data
(60) Provisional application No. 63/707,555, filed on Oct. 15, 2024.

(51) Int. Cl. H05B 47/155; F21V 7/00; F21V 7/04; F21V 21/30; F21Y 105/16; F21Y 115/10; H05B 45/10; H05B 45/20; H05B 47/165

(52) U.S. Cl. CPC H05B 47/155; F21V 7/0066; F21V 7/0083; F21V 7/041; F21V 21/30; H05B 45/10; H05B 45/20; H05B 47/165; F21Y 2105/16; F21Y 2115/10

(57) ABSTRACT

A lighting fixture is provided including superimposed first and second printed circuit boards (PCBs), wherein LEDs on the first, top PCB are provided over a center cluster of LEDs on the second, bottom PCB in order to create a superimposed lighting effect. A processor controls a first group of LEDs on the first PCB independently of a second group of LEDs on the second PCB. A lighting effect is produced in which light from the first group of LEDs is superimposed over, and mixed with, light produced by the second group of LEDs.

### CROSS-REFERENCE TO RELATED APPLICATIONS

The present application claims the priority, under 35 U.S.C. § 119(e), of co-pending U.S. Provisional Ser. No. 63/707,555 filed on Oct. 15, 2024; that application being incorporated herein, by reference, in its entirety.

### BACKGROUND OF THE INVENTION

### Field of the Invention

The present invention relates to a lighting fixture having layered LED lighting. More particularly, a lighting fixture is provided including first and second printed circuit boards (PCBs) positioned in different planes of the optical path, wherein LEDs on the first, top PCB are provided over a center cluster of LEDs on the second, bottom PCB in order to create a superimposed, multi-source lighting effect.

### Description of the Related Art

U.S. Pat. No. 9,781,779, incorporated by reference, herein, discloses an illumination device with a number of light sources arranged in at least two groups of light sources that are individually controllable. The first group of light sources have light collectors such as internal reflection (TIR) lenses, mixers or other lenses placed over them to collect and convert light of the light sources into a number of light source beams. The second group of light sources pass light through diffusing areas of a diffuser in the form of a diffusion cover included in the lamp housing to diffuse the light and create a background light for the first group of light sources. The light from the first group of light sources pass through non diffusing regions of the diffuser cover without the light being diffused. The second group of light sources are interleaved with the first group by the diffuser having one or several diffusion areas between non diffusion areas. By controlling both groups of light sources based on the same target color the dotted look of led light sources can be removed or by controlling the two groups of light sources based on two different colors light effects can be obtained. See, for example, the Abstract of the '779 patent. Both the color and intensity of the second group of light sources can be varied independently of the first group of light sources. A light effect is thus provided in which the area between the light beams can have a color and/or intensity emitted by the second group of light sources that is different from the color and/or intensity emitted by the first group of light sources.

The MAC AURA XB™ lighting fixture by MARTIN® by Harman is one such lighting fixture that includes individually controlled first and second groups of LED light sources disposed on a lower, primary LED PCB superimposed over an upper, secondary LED PCB, respectively. Light rod assemblies transmit light from the first group of LEDS on the primary LED PCB through openings in the secondary LED PCB to produce a lighting effect in combination with the second group of LEDs of the secondary LED PCB, as described in connection with FIG. 4B of the '779 patent.

However, the particular arrangement of the primary and secondary LED PCBs of the MAC AURA XB™ lighting fixture leaves gaps in the light beam as a consequence of the positioning of each of the second group of LEDs of the secondary LED PCB in dispersed locations around each corresponding light rod assembly. What is needed is a lighting arrangement having first and second groups of independently controllable LEDs that creates a cleaner, more complete and uniform light beam.

### BRIEF SUMMARY OF THE INVENTION

The present invention is particularly suited to meet the above-described needs in a manner not previously known or contemplated. It is accordingly an object of the invention to provide a lighting fixture with superimposed, individually controllable groups of LEDs that create a unique lighting effect having a clean, more complete light beam.

Although the invention is illustrated and described herein as embodied in a lighting fixture with superimposed, individually controllable groups of LEDs for creating a lighting effect, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

The foregoing background, as well as the following detailed description of the preferred embodiments, is better understood when read in conjunction with the appended drawings. For the purpose of illustrating the invention, there is shown in the drawings an exemplary embodiment that is presently preferred, it being understood however, that the invention is not limited to the specific methods and instrumentalities disclosed. Additionally, like reference numerals represent like items throughout the drawings. In the drawings:

FIG. 1A is a front plan view of a lighting fixture in accordance with one particular embodiment of the invention shown with the head rotated to face to the front;

FIG. 1B is a rear plan view of the lighting fixture of FIG. 1A shown with the head rotated to the front;

FIG. 1C is a side plan view of the lighting fixture of FIG. 1A with the head rotated to the front;

FIG. 1D is a side plan view of the lighting fixture of FIG. 1A with the head rotated straight upwards, in accordance with one particular embodiment of the invention;

FIG. 1E is a perspective view of the lighting fixture of FIG. 1A showing the front with the head rotated towards the front and partially upward;

FIGS. 1F and 1G are perspective views of the lighting fixture of FIG. 1A showing the front with the head rotated upwards;

FIG. 1H is a partially exploded, isometric view of a lighting fixture in accordance with one particular embodiment of the invention;

FIG. 2 is a simplified block diagram of a control system and certain electronic components for a lighting fixture in accordance with one particular embodiment of the present invention.

FIG. 3 is a simplified, front plan view of a first LED printed circuit board in accordance with one particular embodiment of the invention;

FIG. 4 is a simplified, front plan view of a second LED printed circuit board in accordance with one particular embodiment of the invention;

FIG. 5 is a simplified front plan view of the first LED printed circuit board of FIG. 3 superimposed over the second LED printed circuit board of FIG. 4 (shown in dotted line);

FIG. 6 is a partial, simplified view of a head assembly showing the orientation of a first LED printed circuit board relative to a second LED printed circuit board in accordance with one particular embodiment of the invention;

FIG. 7 is a partial, simplified view of a head assembly showing the orientation of a first LED printed circuit board relative to a second LED printed circuit board and showing the placement of the reflector cones disposed over the LEDs of the second LED printed circuit board between the second LED printed circuit board and the first LED printed circuit board in accordance with one particular embodiment of the invention; and

FIG. 8 is a marked-up front plan view of a lighting fixture useful in understanding one particular embodiment of the invention;

FIG. 9 shows one exemplary macro pre-programmed to individually control the LEDs of the lighting fixture in accordance with one particular lighting program of one particular embodiment of the invention; and

FIG. 10 is a simplified diagram of a system including a plurality of lighting fixtures in accordance with one particular embodiment of the invention that are serially connected together for data transmission.

### DETAILED DESCRIPTION OF THE INVENTION

Before explaining the disclosed embodiment of the present invention in detail, it is to be understood that the invention is not limited in its application only to the details of the particular arrangement shown since the invention is capable of other embodiments. Also, the terminology used herein is for the purpose of description and not of limitation.

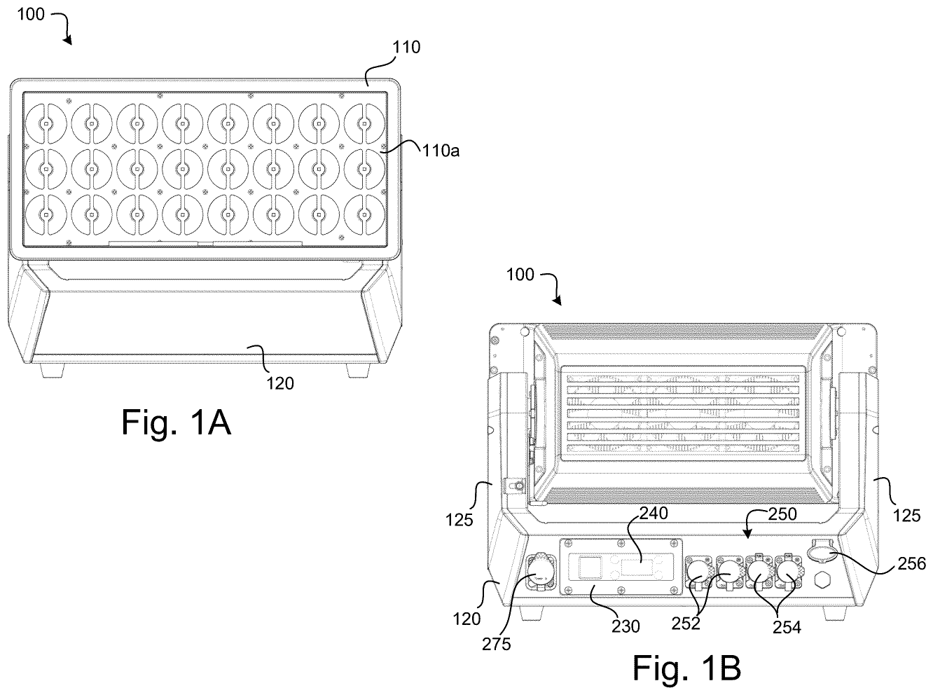

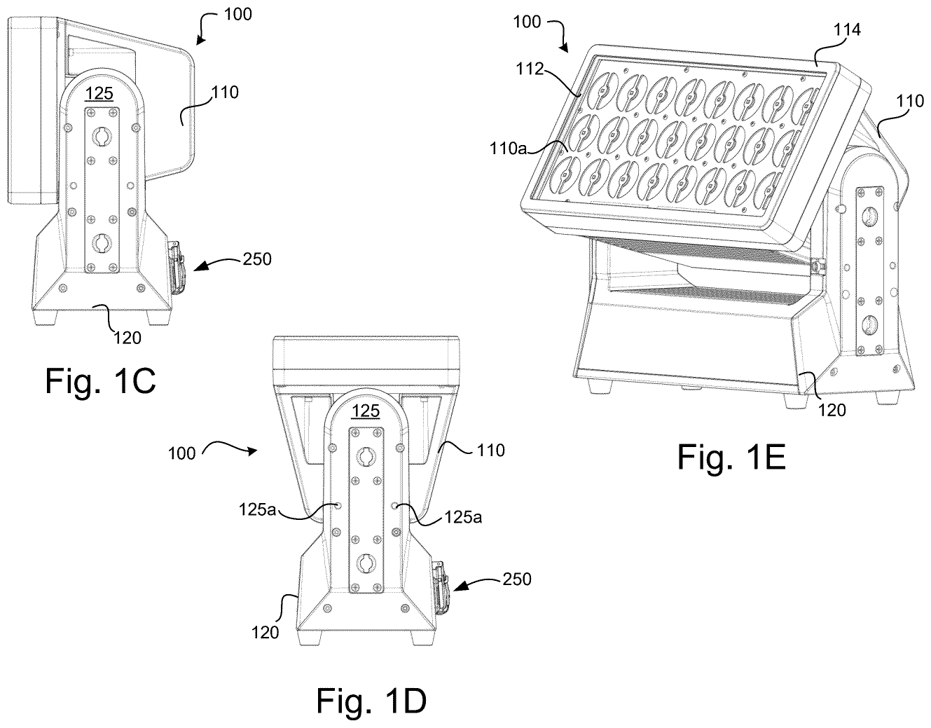

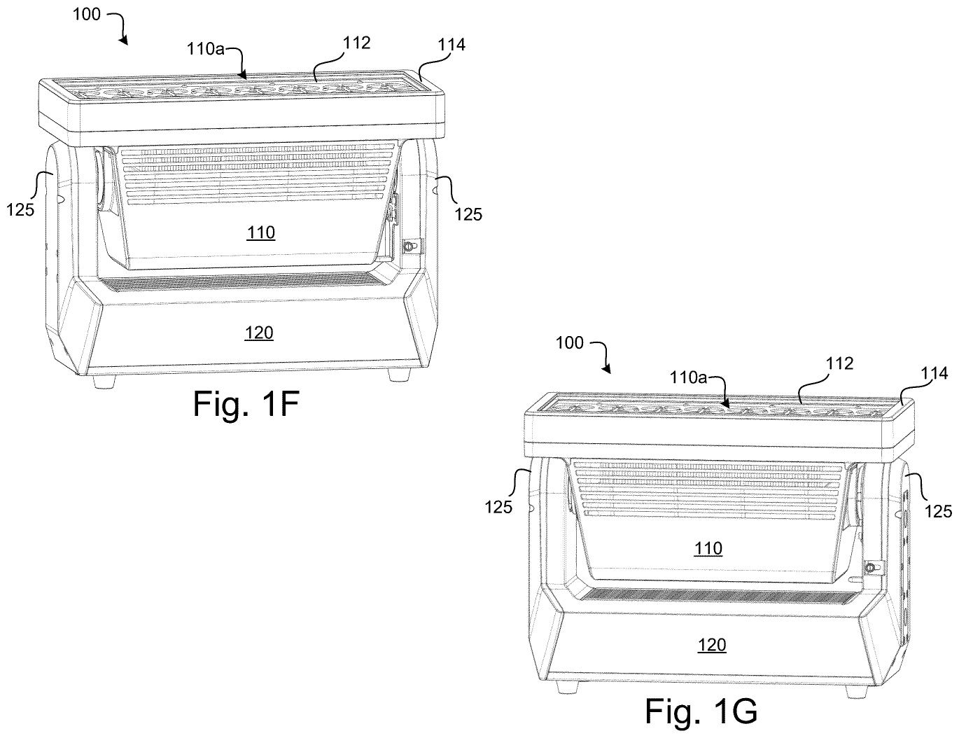

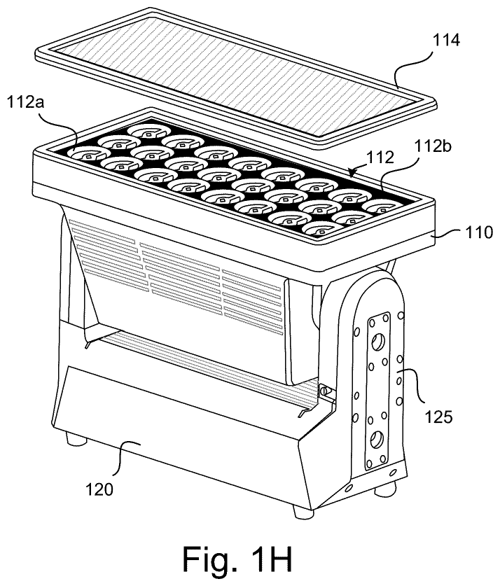

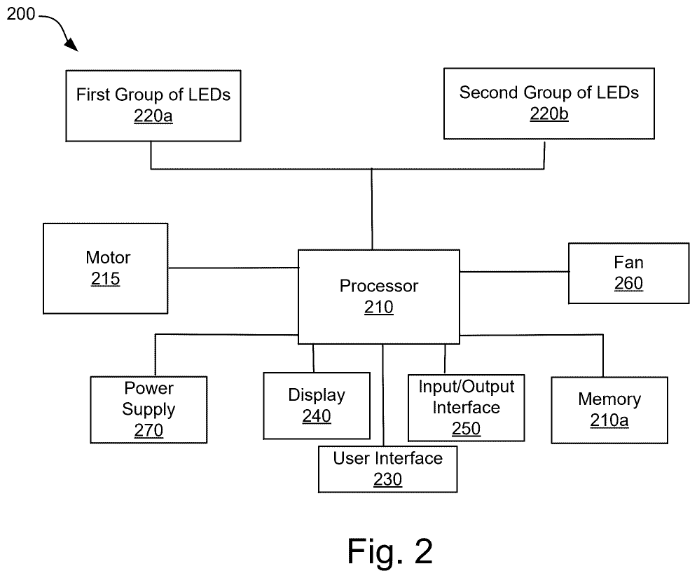

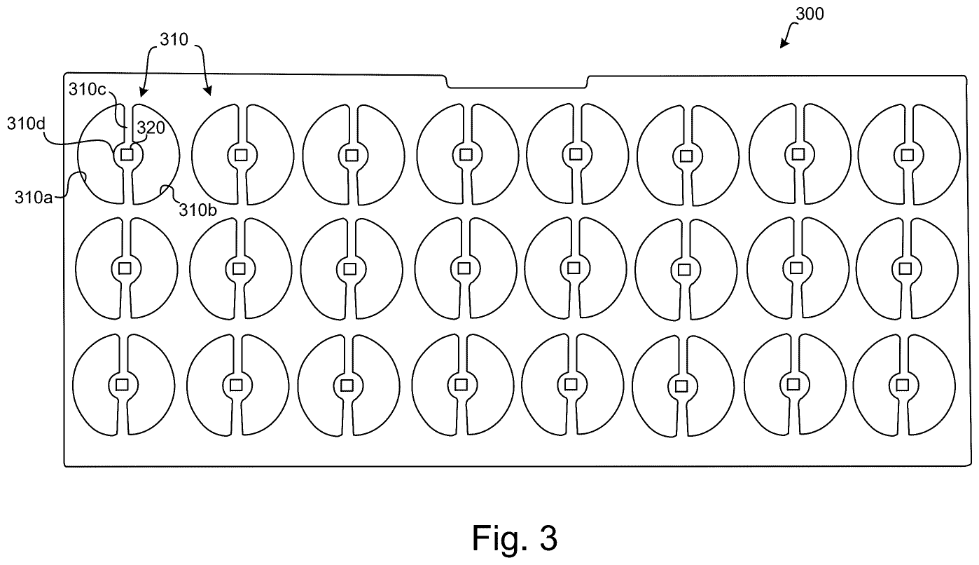

Referring now to FIG. 1A-2, there is shown one particular embodiment of a lighting fixture 100 in accordance with the present invention. The lighting fixture 100 can includes a head 110 connected with a base 120. In one particular embodiment of the invention, the head 110 is rotatably connected to the base via a yoke or arms 125. The control system and components of the lighting fixture 200 are powered by a power supply 270 and controlled by a processor 210 programmed by software and/or configured in hardware to control the motor(s) 215 for rotation of the head 110 relative to the base 120. In one particular embodiment of the invention, the head 110 is rotatable 180° relative to the base 120 about a rotational axis through the yoke 125, thus allowing a front light emission face 110a to be directed between a straight-on front facing orientation and a straight-on rear facing position, and all angles in between. Holes 125a may be provided in both yokes 125 of a fixture 100 to receive guide or alignment pins (not shown) in order to mate adjacent fixtures 100 in perfectly straight linear arrays.

A fan or fans 260 may be provided in the base 120 and/or head 110 of the lighting fixture 100 for cooling. Additionally, a user interface 230 including a display 240 is provided in the base 120 for programming the processor 210 of the lighting fixture 100 locally. Input/Output interfaces 250 are additionally provided in the base 120 to send/receive control signals and programming to/from a remote source and/or from other lighting fixtures 100. In one particular exemplary embodiment, the Input/Output interfaces 250 include 5-pin DMX in/out ports 252, Ethernet through-ports 254 and a USB type-C port 256 for receiving software updates. This is not meant to be limiting, as more or fewer ports, or different types of physical input/output ports, connectors or interfaces may be provided without deviating from the spirit of the present invention. A power-in connector or jack 275 is additionally provided in the base to provide power from an external power source to the power supply 270.

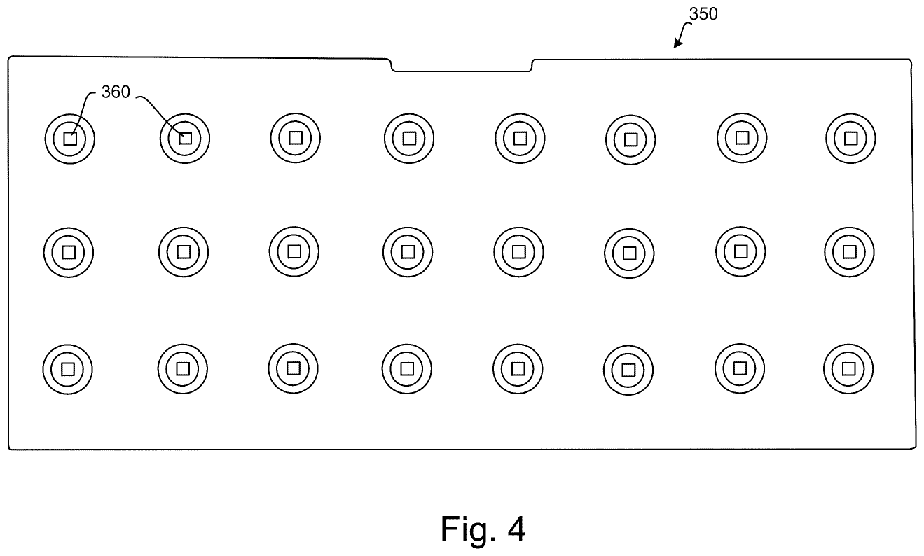

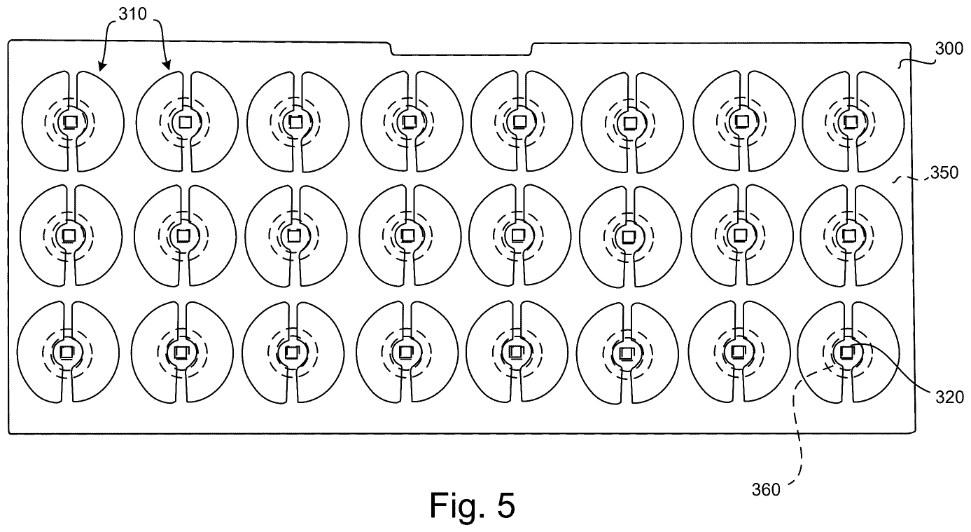

Referring now to FIG. 1A-5, the head 110 includes the circuitry for providing the lighting effects in response to signals from the processor 210. In particular, the head 110 includes at least a first LED printed circuit board (PCB) 300 superimposed in the head 110 over a second LED PCB 350. Additionally, a lens 112 and/or a filter or diffuser 114 may be placed in or on the head 110 over the first LED PCB 300 to close the head 110 and provide the desired optical properties. As can be seen more particularly in FIG. 1H, in one particular embodiment, the lens 112 includes a mask that is transparent in the regions 112a over the openings 310 in the first LED PCB 300 and that is opaque in the regions 112b between openings 310 in the first LED PCB 300. In another particular embodiment, the diffuser 114 may be an electronic diffuser powered and controlled by the lighting fixture 100 to provide variable diffusion.

Referring now to FIG. 2-5, the first LED PCB 300 includes a plurality of openings 310. Each opening 310 includes left and right semicircular cut-outs or open portions 310a, 310b separated by a PCB bridging section 310c. The PCB bridging section 310c includes a circular pad 310d approximately centered in the opening 310. An LED 320 is mounted on each circular pad 310d of each opening 310 of the first LED PCB 300. The plurality of LEDs 320 on the first LED PCB form a first group of LEDs 220a individually and collectively controllable by the processor 210 in accordance with programs stored in the lighting fixture or control signals received via the input/output interface 250.

The second LED PCB 350 additionally includes a plurality of LEDs 360. In particular, there will be one LED 360 on the second LED PCB 350 aligned with each opening 310 on the first LED PCB 300. The LEDs 360 on the second LED PCB together form a second group of LEDs 220b individually and collectively controllable by the processor 210 in accordance with programs stored in the lighting fixture or control signals received via the input/output interface 250. The processor 210 can control the first group of LEDs 220a independently from the second group of LEDs 220b, and vice versa. In other words, an effect may be produced where the intensity and/or color of the LEDs 320 of the first group of LEDs 220a is/are different than the intensity and/or color of the LEDs 360 of the second group of LEDs 220b. Additionally, each of the LEDs in each group 220a, 220b is individually controllable separate from the other LEDs of that group by the processor 210.

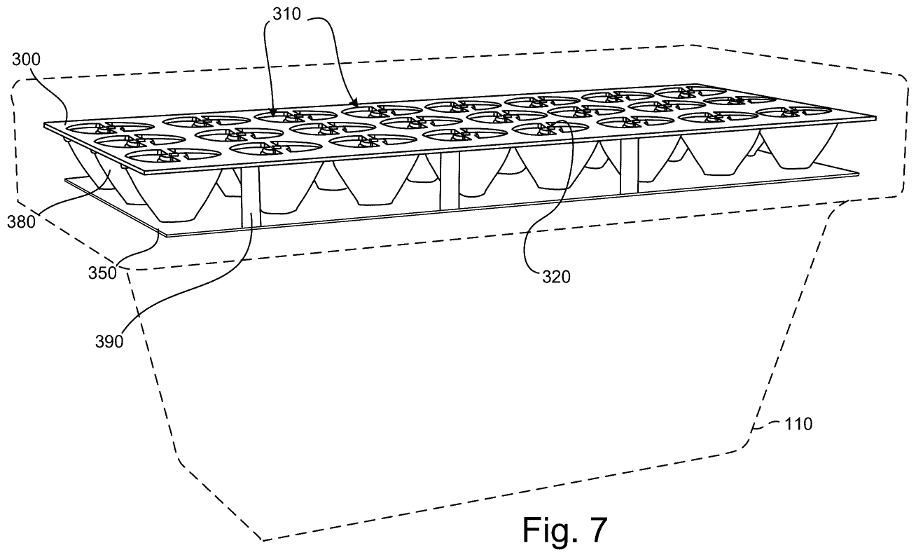

The LED PCBs 300, 350 are fixed relative to one another in the head 110 and spaced apart from one another in order to accommodate a set of frusto-conical reflector cups 380 centered around the LEDs 360 on the second LED PCB 350. The first LED PCB 300 is fixedly superimposed over the second LED PCB 350 at a predetermined distance from the second LED PCB 350 using spacers 390 sized to accommodate the frusto-conical reflector cups 380 (FIG. 7) between the PCBs 300, 350. In one embodiment, the bottom of each of the frusto-conical reflector cups 380 is mounted to the second LED PCB 350 around a respective one LED 360 that is substantially centered in the one reflector cup 380. In that embodiment, the top of each reflector cup 380 is in contact with the underside (the side facing away from the light emission face 110a of the head 110) of the first LED PCB 300 surrounding a respective opening 310 having an LED 320 mounted therein.

The first and second LED PCBs 300, 350 are assembled relative to one another such that each LED 320 on the first LED PCB 300 is arranged approximately directly over a corresponding LED 360 on the second LED PCB 350. This can be used to create an effect where light from the LEDs 320 on the first LED PCB 300 is provided in the center of the circle of light produced by the LEDs 360 on the second LED PCB 350 and reflected by the cups 380 out of the semicircular cutouts 310a, 310b of each opening 310 in the first LED PCB 300. The reflected light from the LEDs 360, therefore, surrounds and, to some extent mixes with, the light emitted by the LEDs 320 on the first LED PCB 300. A combined light from the LEDs 320, 360 is emitted from the front light emission face 110a of the head 110, through the mask of the lens 112 and/or through the filter or diffuser 114. Additionally, in one particular embodiment of the invention, a magnetically attachable stealth filter 114 is provided to selectively cover/hide the LEDs when the fixture 100 is not in use.

Each of the LEDs 320, 360 are multi-color LEDs, as are known in the art. The beam angle of the LEDs 360 can be selected to optimize reflection by the cup 380. The processor 210 is configured to control the intensity and color of the LEDs in the first and second groups of LEDs 220a, 220b. One particular desired effect is produced when the intensities and/or colors of the LEDs 320 of the first group of LEDs 220a are different from the intensities and/or colors of the LEDs 360 of the second group of LEDs 220b. In this way, an effect is produced wherein, for each opening 310, light of a first color and/or intensity produced by an LED 320 is superimposed over light of a second, different color and/or intensity reflected through the opening 310 from an LED 360.

Another desired effect is produced when the processor 210 controls the intensities and/or colors of both groups of LEDs 220a, 220b to be the same. Such an effect can be used to produce a clean, uniform beam of light of uniform color and/or intensity.

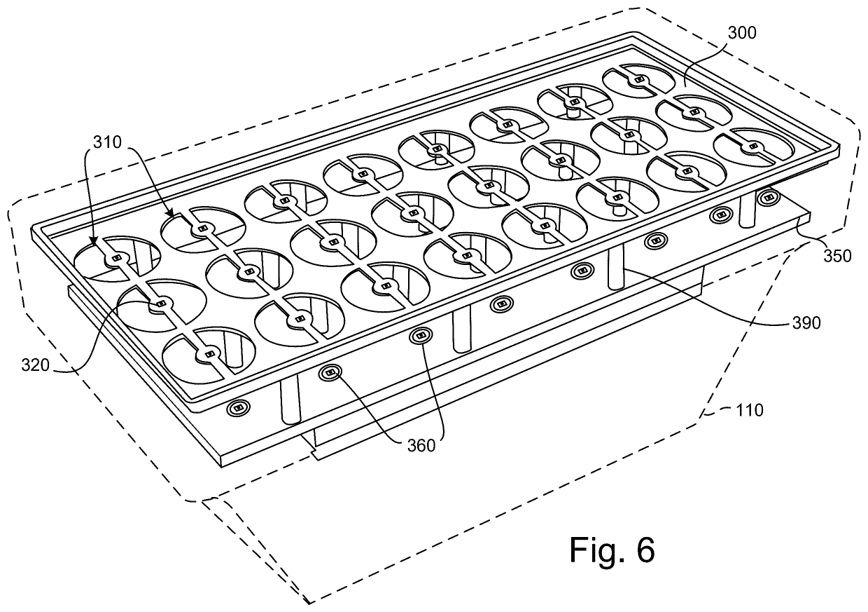

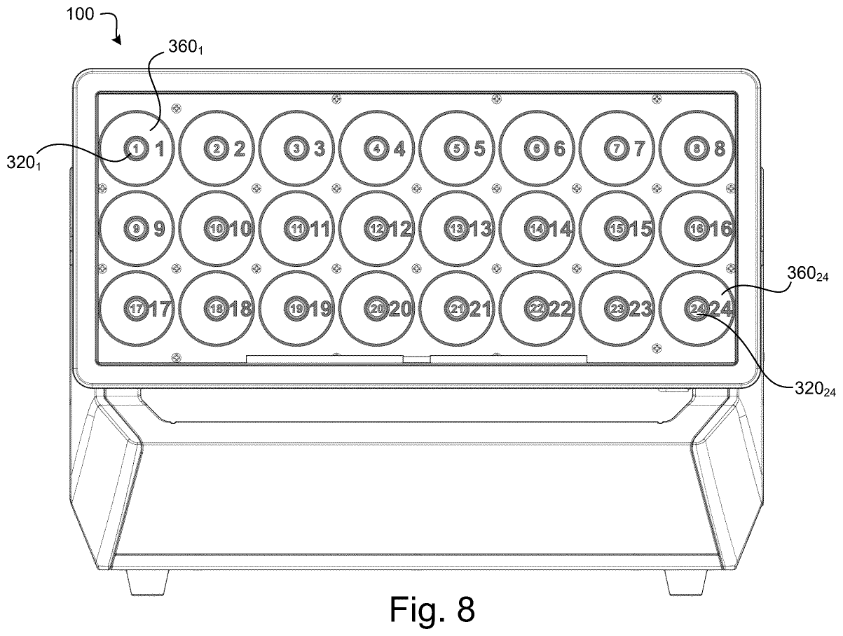

It has been described in the foregoing that the LEDs are controlled in groups 220a, 220b. However, it should be understood that, in one particularly preferred embodiment of the invention, each LED 320, 360 of the groups 220a, 220b is individually controllable by the processor 210. Referring now to FIGS. 1A-8, a system and method will be described for operating a lighting fixture 100 in accordance with one particular embodiment of the invention. The lighting fixture 100 includes a plurality of aligned LED pairs, each LED of which is individually addressable. In the present embodiment illustrated, the lighting fixture 100 includes 24 sets of aligned LED pairs, or 48 individually addressable LEDs (i.e., LEDs 320₁-320₂₄ of the upper circuit board 300 and LEDs 360₁-360₂₄ of the lower circuit board 350). This is not meant to be limiting, as lighting fixture 100 may include more or fewer LED pairs, as desired, without limiting the scope or spirit of the invention.

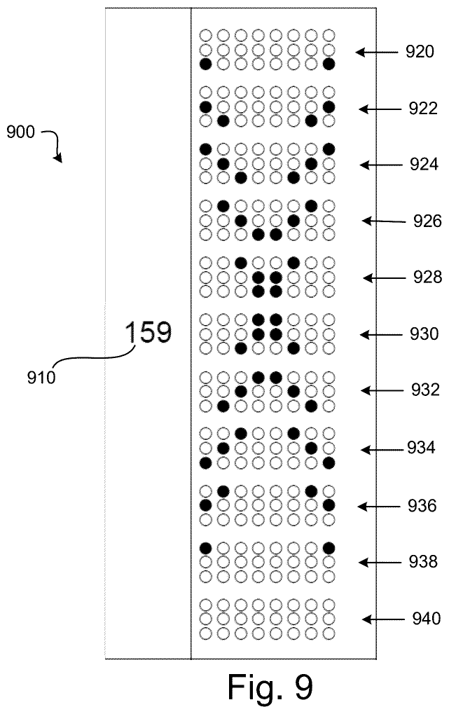

As discussed herein, the processor 210 may be used to control each of the LEDs 320₁-320₂₄ and 360₁-360₂₄, individually, according to instructions received or generated by the lighting fixture 100. More particularly, macros may be stored in a memory 210a accessible by the processor 210 that, when executed by the processor 210 activate one or more inner “dot” LEDs 320₁ -320₂₄ and/or one or more surrounding “cell” LEDs 360₁-360₂₄. FIG. 9 shows one exemplary macro 900 pre-programmed to individually control the LEDs of the lighting fixture in accordance with one particular lighting program. More particularly, the macro 900 has a call value or number 910 (i.e., “159” in the present example) that when received by the processor 210, causes the processor to retrieve and execute the macro that performs a lighting program indicated by that call value. For example, when the lighting fixture receives an order for the pre-programmed macro 159, the processor 210 executes the lighting program shown, wherein, in a first step, 920, foreground dot LEDs (shown as dark circles) and rear-lit cell LEDs (shown as open circles) are activated according to the pattern shown. The macros can additionally include instructions regarding the color mixes, flash and intensity settings for each activated dot and cell and tilt settings for the head 120. The macro then cycles sequentially through the steps 922-940 to generate the lighting program represented by the value “159” in memory. Hundreds of macros representing hundreds of pre-stored lighting programs can be stored in the memory 210a. In this way, complex lighting programs can be called up and executed with minimal data being sent to the fixture 100. For example, instead of sending instructions for generating each of the steps 920-940 to each fixture, only the macro value “159” need be transmitted to the fixture or entered on the user interface. This additionally aids the user to more easily program execution of known effects by the fixture 100.

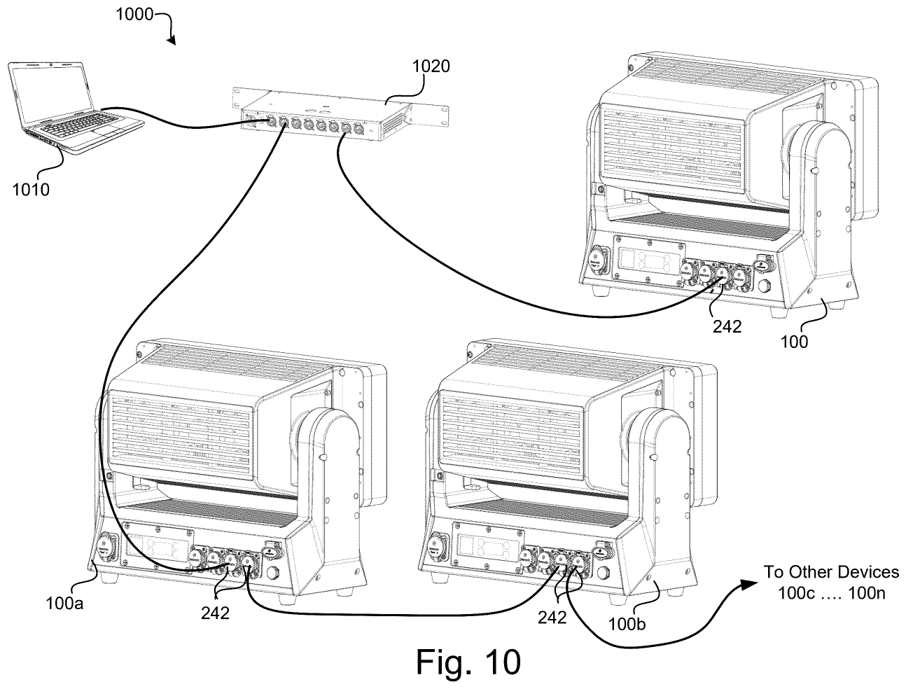

Referring now to FIG. 10, there is shown one exemplary system 1000 in which one or more lighting fixtures 100 according to the invention can be connected via an Ethernet connection. A computer/controller 1010 is connected to a switch or router 1020 to provide signals to all lighting fixtures 100 of the system. Note that a wireless protocol, such as BLUETOOTH™ may additionally or alternatively be used to connect the computer/controller 1010 to the lighting fixtures 100, if desired. In the present embodiment, the computer/controller 1010 may be running ART-NET™ or the sACN protocol to communicate with the lighting fixtures 100. In particular, the switch or router 1020 may be connected to a lighting fixture 100 using an Ethernet protocol (such as ART-NET™ or ACN), via the Ethernet port 254, to transport DMX512 data over IP or any other compatible network.

Other lighting fixtures 100a, 100b . . . 100n may be serially connected to one another and operated in a master/slave mode such that one lighting fixture 100a, acting as the master, controls one or more other lighting fixtures 100b . . . 100n, without a DMX controller. In such, one lighting fixture 100a becomes the master, while running an auto program or in a Static mode. Each slave device 100b . . . 100n will be configured, via the control panel, to operate in a slave mode, such that the slave devices will operate in unison with the master device. Ethernet connectivity allows data to pass from fixture to fixture, even if fixture power is lost.

It should be understood that, as an alternative to the configuration shown in FIG. 10, the lighting fixtures 100a . . . 100n may be serially connected or daisy-chained via the DMX ports 252 when connected to a DMX controller, in order for DMX signals to be passed to each fixture 100a . . . 100n. Additionally, Remote Device Management may be used to communicate bi-directionally along existing DMX cabling, if desired.

Although a preferred embodiment of the present invention has been described, it is understood that the invention is not intended to be limited only thereto. For example, the drawings shown a lighting fixture having a rectangular face. However, it should be understood that the principles of the present invention can be used in a lighting fixture having a circular output face, without departing from the scope or spirit of the present invention.

Additionally, although the invention is described as having “LEDs of a first group” and “LEDs of a second group”, it should be understood that each LED of the first group may be one or more 4 in 1 RGBW LEDs including multiple LED dye to produce a colored light beam. Additionally, it should be understood that each “LED of the second group” can include one or more 4 in 1 RGBW LEDs. In one particular embodiment, each LED of the second group is formed by a cluster of 4 in 1 RGBW LEDs. Thus it should be understood that the term “LED”, used herein in the singular, is intended to encompass a plurality (or cluster) of LEDs and/or a plurality of LED dyes that together form a single light beam.

While the invention has been described, disclosed, illustrated and shown in various terms of certain embodiments or modifications, which it has presumed in practice, the scope of the invention is not intended to be, nor should it be deemed to be, limited thereby and such other modifications or embodiments as may be suggested by the teachings herein are particularly reserved, especially as they fall within the breadth and scope of the claims here appended. Accordingly, while a preferred embodiment of the present invention is shown and described herein, it will be understood that the invention may be embodied otherwise than as herein specifically illustrated or described, and that within the embodiments certain changes in the detail and construction, as well as the arrangement of the parts, may be made without departing from the principles of the present invention as defined by the appended claims.

We claim:

1. A lighting fixture, comprising:
a first light emitting diode (LED) printed circuit board (PCB) including a first group of LEDs;
a second LED PCB including a second group of LEDs;
said first LED PCB disposed between said second LED PCB and a light emission face of the lighting fixture;
said first LED PCB configured such that light emitted from said second group of LEDs is provided around light emitted from said first group of LEDs; and
a processor configured to control said first group of LEDs independently of said second group of LEDs.

2. The lighting fixture according to claim 1, wherein said processor is additionally configured to independently control each LED of a respective first group or second group independently from every other LED of said respective first group or said second group.

3. The lighting fixture according to claim 2, further comprising a non-transitory memory device storing a plurality of macros, each macro executable by said processor to perform a pre-stored lighting program in which each LED of said first group and said second group are controlled by said processor in accordance with the pre-stored lighting program.

4. The lighting fixture according to claim 1, wherein said first LED PCB includes a plurality of openings, with each LED of said first group being centered in a respective one of said plurality of openings and light emitted by said second group of LEDs passes through said plurality of openings around each LED of said first group.

5. The lighting fixture according to claim 4, further comprising a lens disposed adjacent to said light emission face between said first PCB and said light emission face, said mask including a plurality of transparent regions over said openings and opaque regions between said openings.

6. The lighting fixture according to claim 4, wherein said processor sets the color and/or intensity of said first group of LEDs to be different from the color and/or intensity of said second LEDs to produce a lighting effect in which light of a first color and/or intensity produced by an LED of said first group appears to be superimposed over light of a second, different color and/or intensity provided through an opening of said plurality of openings from an LED of said second group of LEDs.

7. The lighting fixture according to claim 4, wherein each opening of said plurality of openings includes two approximately semicircular openings around each LED of said first group.

8. The lighting fixture according to claim 4, further comprising a plurality of reflectors disposed between said second LED PCB and said first LED PCB, each reflector of said plurality of reflectors arranged around a respective LED of said second group to reflect light from said respective LED of said second group through an opening around an associated LED of said first group.

9. The lighting fixture according to claim 8, wherein each reflector is a frusto-conical cup mounted on said second LED PCB with an LED of said second group of LEDs substantially centered in said cup, said top of said cup contacting said first LED PCB around an opening of said first LED PCB.

10. A lighting fixture, comprising:
a first light emitting diode (LED) printed circuit board (PCB) including at least a first LED;
a second LED PCB including at least a second LED;
said first LED PCB disposed between said second LED PCB and a light emission face of the lighting fixture with said at least a first LED superimposed over said at least a second LED;
said first LED PCB including at least one opening proximal to said at least a first LED such that light emitted by said at least a second LED passes through said at least one opening proximal to said at least a first LED; and
a processor configured to control said at least a first LED independently of said at least a second LED.

11. The lighting fixture according to claim 10, wherein said at least one opening in said first LED PCB partially surrounds said at least a first LED and light emitted by said at least a second LED passes through said at least one opening around said at least a first LED.

12. The lighting fixture according to claim 11, wherein said at least one opening includes two approximately semicircular openings around said at least a first LED.

13. The lighting fixture according to claim 12, further comprising at least one reflector disposed between said second LED PCB and said first LED PCB, said reflector being arranged around said at least a second LED to reflect light from said at least a second LED through said at least one opening around said at least a first LED.

14. The lighting fixture according to claim 13, wherein said reflector includes a frusto-conical cup mounted on said second LED PCB with said at least a second LED substantially centered in said cup, said top of said cup contacting said first LED PCB around said at least one opening of said first LED PCB.

15. The lighting fixture according to claim 11, wherein:
said at least a first LED on said first LED PCB is a plurality of first LEDs on said first LED PCB;
said at least a second LED is a plurality of second LEDs on said second LED PCB, each second LED of said plurality of second LEDs being aligned with a respective first LED on said first LED PCB; and
said at least one opening on said first LED PCB including at least one opening through said first LED PCB proximal to each first LED of said plurality of first LEDs on said first LED PCB, such that light emitted by each second LED passes through an opening proximal to a respective first LED with which that second LED is aligned.

16. The lighting fixture according to claim 15, wherein said at least one opening proximal to said each first LED includes two approximately semicircular openings around said respective first LED.

17. The lighting fixture according to claim 16, further comprising a plurality of reflectors disposed between said second LED PCB and said first LED PCB, each reflector of said plurality of reflectors arranged around a respective one second LED of said plurality to reflect light from said respective second LED through said opening around an associated first LED.

18. The lighting fixture according to claim 17, wherein each reflector is a frusto-conical cup mounted on said second LED PCB with a respective one second LED substantially centered in said cup, said top of said cup contacting said first LED PCB around an opening of said first LED PCB.

19. The lighting fixture according to claim 15, wherein said processor individually sets the color and/or intensity of each first LED and each said second LED to produce a lighting effect.

20. The lighting fixture according to claim 15, wherein said processor sets the color and/or intensity of said first group of LEDs to be different from the color and/or intensity of said second LEDs to produce a lighting effect in which light of a first color and/or intensity produced by an LED of said first group appears to be superimposed over light of a second, different color and/or intensity provided through an opening of said plurality of openings from an LED of said second group of LEDs.
